(19) United States
(12) Patent Application Publication
(10) Pub. No.: US 2026/0276060 A1
(43) Pub. Date: Sep. 17, 2026

(54) Double Stack Locking Cleat

(71) Applicant: Panduit Corp., Tinley Park, IL (US)

(72) Inventors: Andrew W. Booth, Pickering (GB); Michael R. Stabrawa, Frankfort, IL (US); Rodney G. Rouleau, Lake Village, IN (US); Nicholas M. Molenhouse, New Lenox, IL (US)

(73) Assignee: Panduit Corp., Tinley Park, IL (US)

(21) Appl. No.: 19/683,864

(22) Filed: May 21, 2026

Related U.S. Application Data
(63) Continuation-in-part of application No. 19/227,720, filed on Jun. 4, 2025.
Application No. 19/227,720 is a continuation of application No. 18/420,049, filed on Jan. 23, 2024, now Pat. No. 12,372,138.

(51) Int. Cl. F16G 11/06

(52) U.S. Cl. CPC F16G 11/06

(57) ABSTRACT

A ball locking cleat including a housing, a strap configured to be positioned within the lower aperture, the upper aperture, or both, and a locking ball configured to be positioned within the ball locking portion and couple to the strap. The housing may include a top, a bottom, a front, a back, a first side, a second side, and a divider. The housing is configured to define an interior space that may include a lower aperture positioned between the bottom and the divider, an upper aperture positioned between the divider and the top, and a ball lock portion extending from the upper aperture.

### CROSS REFERENCE TO RELATED APPLICATION(S)

This application is a continuation in part of U.S. Patent Application Serial No. 19/227,720 filed on June 4, 2025, which is a continuation of U.S. Patent Application Serial No. 18/420,049, filed on January 23, 2024, the subject matter of which are hereby incorporated by reference in its entirety.

### FIELD OF THE INVENTION

The present invention relates to a locking cleat, and more particularly to a double stack locking cleat.

### BACKGROUND OF THE INVENTION

Conventional cable cleats have been typically used to secure wire or cable bundles to panels, ladder racks, or similar structural support members. The cable cleats include a mounting surface and a body portion that receives the wires or a cable bundle. It is also known to use MS 75 strap cleats to secure cables for short circuit protection. While the known cleats provide desirable characteristics for certain applications, they still have drawbacks and are capable of improvement. Conventional cable cleats are generally difficult and time consuming to install.

It is desirable to provide an improved strap locking cleat solution for short circuit protection that is lower in cost and easier to install. It is also desirable to provide a strap locking cleat solution that is flexible and accommodates a range of cable sizes.

Metallic bundling devices incorporating locking balls and roller pins have been used for bundling bales of cotton or the like since the Nineteenth Century. None of the prior devices were positive locking i.e., depending on the orientation of the locking head, gravity could hold the ball out of locking engagement with the strap resulting in release. U.S. Pat. No. 4,399,592 addresses this problem by teaching the addition of a raised portion or protuberances for deflecting the threaded strap away from the floor as the threaded strap exits the locking head. This deflection ensures that the locking ball is in continuous engagement with the threaded strap regardless of the position of the ball or the orientation of the locking head.

U.S. Pat. No. 8,635,745 discloses a metal ball locking tie with a bi-level head. The metal locking tie with bi-level head has a high loop tensile strength compared to other metal locking ties. The metal ball locking tie with bi-level head, however, is difficult to manufacture. A progressive die is required to stamp the bi-level head which would require a number of stamping stations, a large die, and a large press bed. Additionally, threading multiple tie loops through the bi-level head is complicated and too difficult when the metal locking tie is wrapped around a small diameter cable bundle. As such, it is presently recognized that an improved metal locking cleat for securing a cable or a bundle of cables that is easier to install and capable of withstanding strong impulse forces or short circuit events is desired.

### SUMMARY OF THE INVENTION

The invention is directed to a locking cleat secured to at least one cable. The locking cleat includes a housing, a strap, a threaded screw, and a nut. The housing has a top, a bottom, a front, a back, and sides. The housing also includes a lower aperture and an upper aperture. The strap is positioned within the lower aperture of the housing, and the nut is positioned within the upper aperture of the housing. The threaded screw is positioned within the housing to engage the strap to secure the locking cleat on the at least one cable.

In an instance, the invention is directed to a locking cleat including a housing, a strap configured to be positioned within the lower aperture, the upper aperture, or both, and a locking ball configured to be positioned within the ball locking portion and couple to the strap. The housing may include a top, a bottom, a front, a back, a first side, a second side, and a divider. The housing is configured to define an interior space that may include a lower aperture positioned between the bottom and the divider, an upper aperture positioned between the divider and the top, and a ball lock portion extending from the upper aperture.

In other instances, the invention is directed to a locking cleat including a housing and a strap. The strap may be configured to surround one or more cables and threaded through the lower aperture and threaded through the upper aperture and coupled to a locking ball.

### BRIEF DESCRIPTION OF THE DRAWINGS

FIG. 1 is a perspective view of a double stack locking cleat of the present invention secured to a cable.

FIG. 2 is a front view of the double stack locking cleat of FIG. 1 secured to the cable.

FIG. 3 is a top exploded view of the double stack locking cleat of FIG. 1.

FIG. 4 is a bottom exploded view of the double stack locking cleat of FIG. 1.

FIG. 5 is a partially exploded view of the double stack locking cleat of FIG. 3.

FIG. 6 is a bottom perspective view of the partially assembled double stack locking cleat of FIG. 5.

FIG. 7 is a partially exploded view of the double stack locking cleat of FIG. 5.

FIG. 8 is a perspective view of the assembled double stack locking cleat of FIG. 3.

FIG. 9 is a perspective view of the double stack locking cleat of FIG. 8 with the strap fed through the housing of the locking cleat.

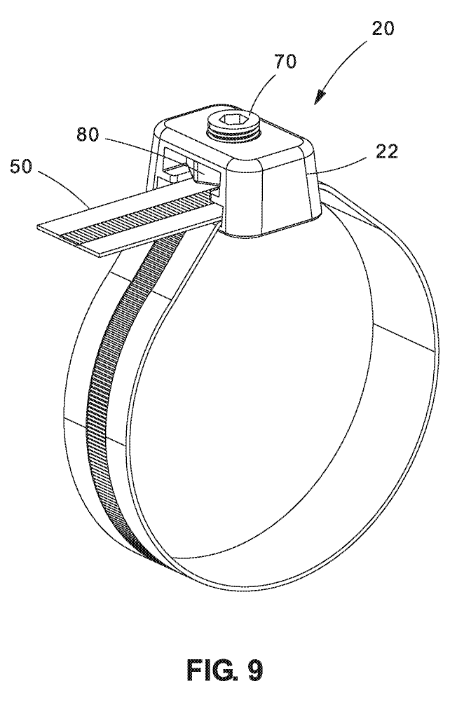

FIG. 10 is a perspective view of another embodiment of the double stack ball locking cleat of the present invention with a strap fed through a housing of the double stack ball locking cleat.

FIG. 11 is a front view of the double stack ball locking cleat of FIG. 10 without a locking ball and a ball retention tab in a first configuration.

FIG. 12 is a front view of the double stack ball locking cleat of FIG. 10 with the locking ball and the ball retention tab in a second configuration.

FIG. 13 is a cross-sectional view of the double stack ball locking cleat of FIG. 10 without the locking ball.

FIG. 14 is a cross-sectional view of the double stack ball locking cleat of FIG. 10 with a bottom that is shorter than a divider.

FIG. 15 is a cross-sectional view of the double stack ball locking cleat of FIG. 10 with the strap fed through the housing.

### DETAILED DESCRIPTION

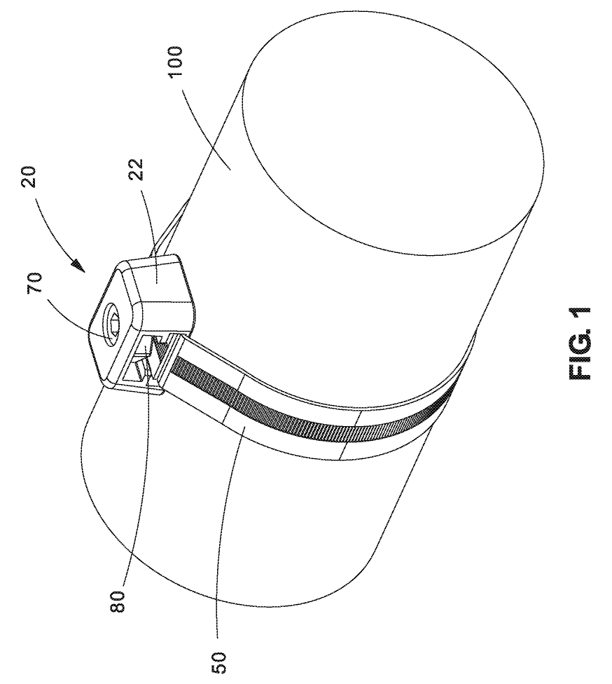

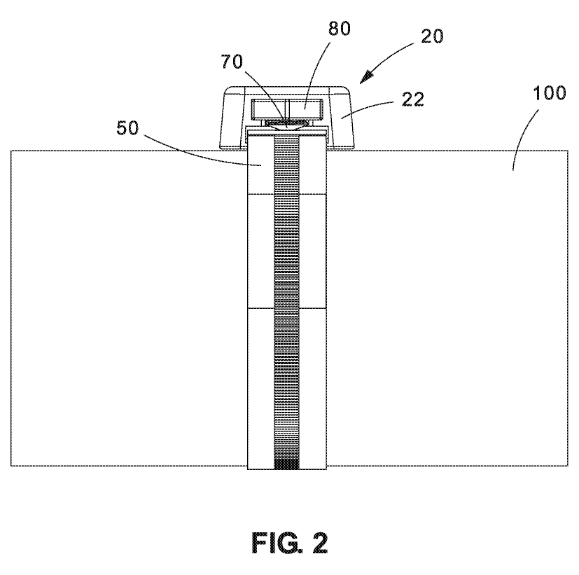

FIGS. 1 and 2 illustrate the double stack locking cleat 20 of the present invention secured around a single cable 100. Although the double stack locking cleat 20 is illustrated installed around a single cable 100, the double stack locking cleat 20 may also be installed around a bundle of cables.

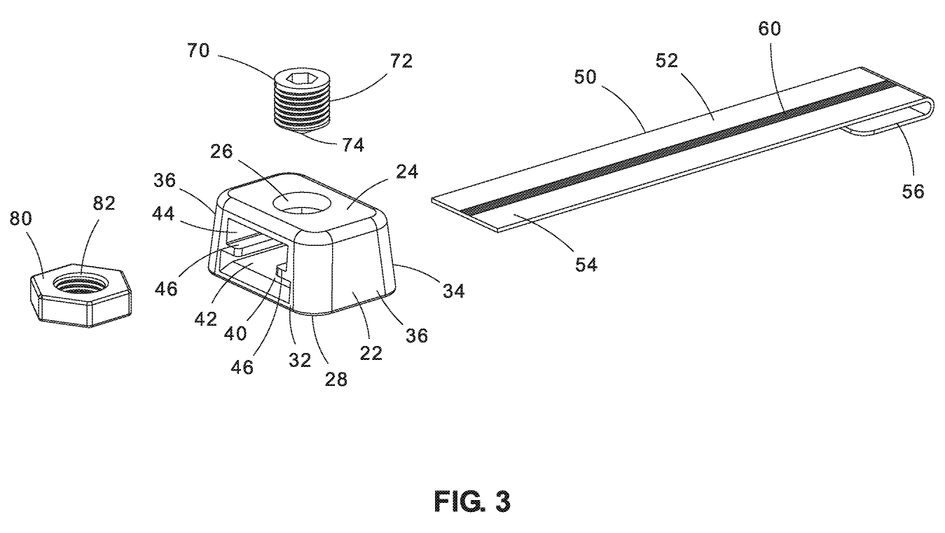

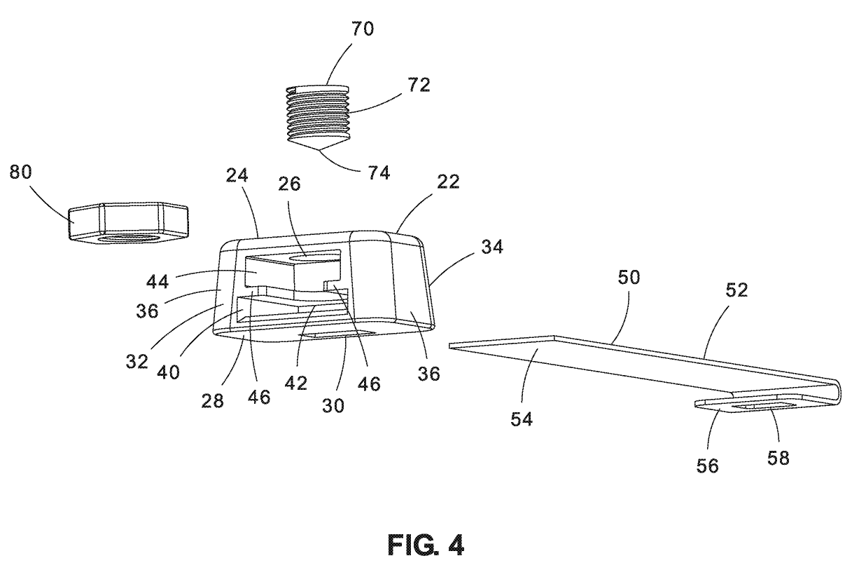

FIGS. 3 and 4 illustrate the components of the double stack locking cleat 20. The double stack locking cleat 20 includes a housing 22, a strap 50, a threaded tapered screw 70, and a nut 80. The housing 22 is cast steel or aluminum or injection molded. The housing 22 includes a top 24, a bottom 28, a front 32, a back 34, and sides 36. The housing 22 also includes a lower aperture 40, an upper aperture 44, a circular hole 26 through the top 24, and a rectangular opening 30 through the bottom 28. The lower aperture 40 extends from the front 32 to the back 34 of the housing 22 defining a pathway 42 for the strap 50. The bottom front 32 of the housing 22 is angled to aid the wrapping of the strap 50 around the cable 100. The housing 22 also includes two internal arms 46 that extend from the sides 36 toward the center of the housing 22. The internal arms 46 separate the lower aperture 40 and the upper aperture 44.

The strap 50 includes a main body 52 with a first free end 54 and a second fold over end 56. The fold over end 56 includes a spring finger 58 positioned between the folded end 56 and the strap main body 52. The strap 50 also includes a continuous knurled recess 60 extending along the length of the strap 50.

The threaded tapered screw 70 includes threads 72 and a point 74 at one end and the nut 80 includes internal threads 82.

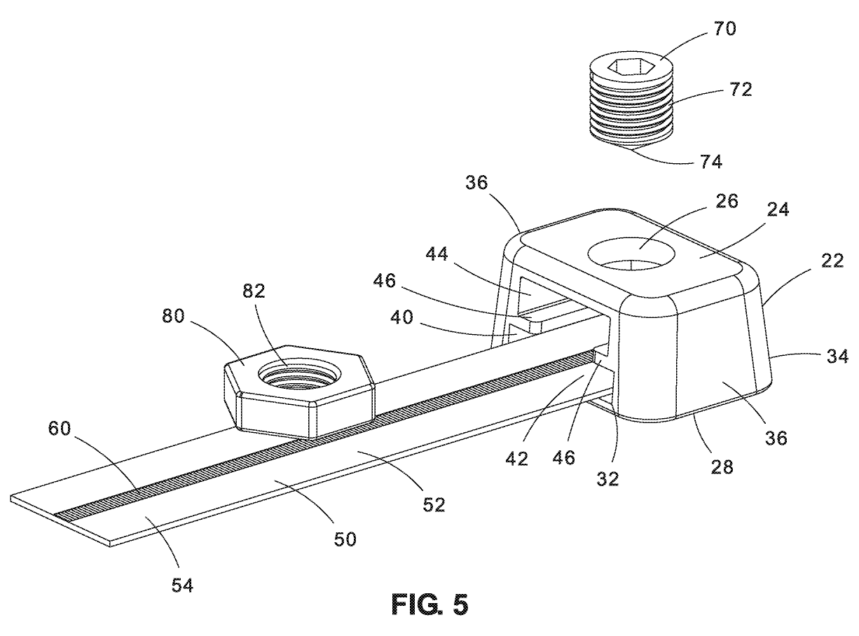

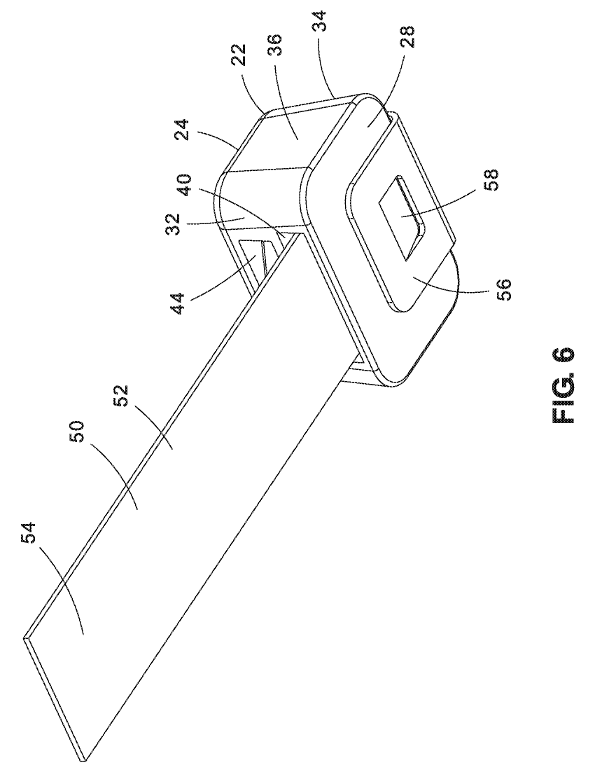

FIGS. 5-6 illustrate the strap 50 initially installed in the housing 22 of the locking cleat 20. The strap 50 is inserted through the lower aperture 40 sufficiently to clear the fold over end 56. Next, the strap 50 is pulled back on itself so the spring finger 58 engages the rectangular recess 30 in the bottom 28 of the housing 22.

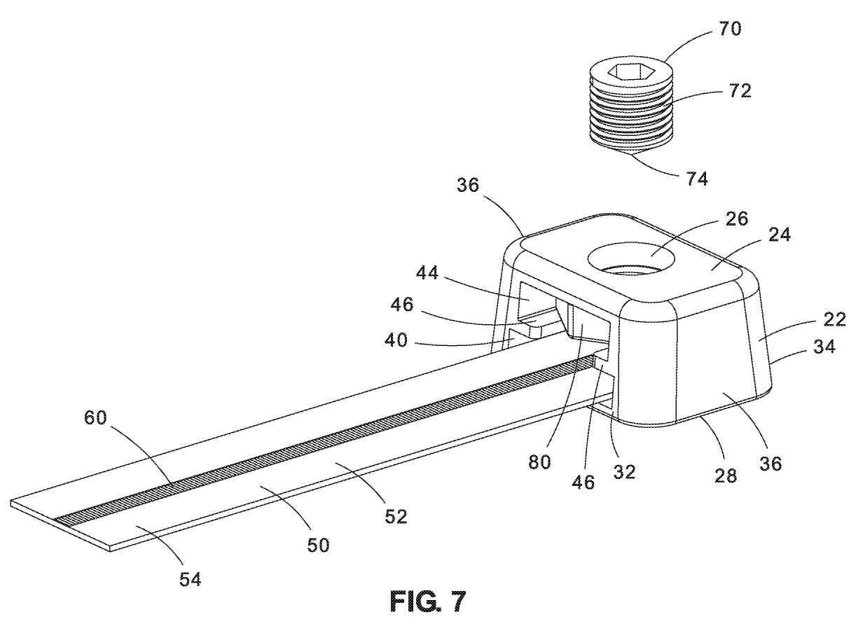

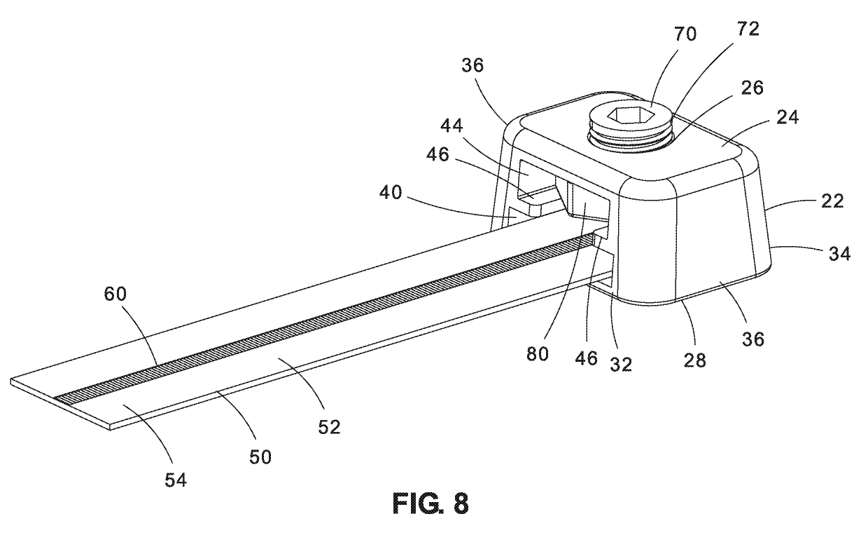

As illustrated in FIG. 7, the nut 80 is inserted into the upper aperture 44 of the housing 22 of the locking cleat 20. The nut 80 engages the back 34 of the housing 22 and is positioned on the internal arms 46 in the housing 22. The nut 80 is aligned with the circular hole 26 in the top of the housing 22. As illustrated in FIG. 8, the threaded tapered screw 70 is inserted through the circular hole 26 in the top 24 of the housing 22 of the locking cleat 20. The threaded tapered screw 70 is threaded into the nut 80 to secure the screw 70.

To install the locking cleat 20, the strap 50 is wrapped around a cable 100 or a bundle of cables and then fed back through the lower aperture 40 in the housing 22 of the locking cleat 20. The strap 50 may be wrapped around the cable 100 or bundle of cables and feed through the lower aperture 40 once, twice or any number of times, as desired. After the strap 50 wrap around is complete, the strap 50 is tightened by using the appropriate hand tool, if necessary. Next, the threaded tapered screw 70 is fully tightened. The point 74 at the end of the screw 70 becomes positioned within one of the knurled recesses 60 extending along the strap 50. Once the threaded tapered screw 70 is tightened into the strap, the strap will not be able to release. After the strap 50 has been secured, the free end 54 of the strap is cut by a hand tool.

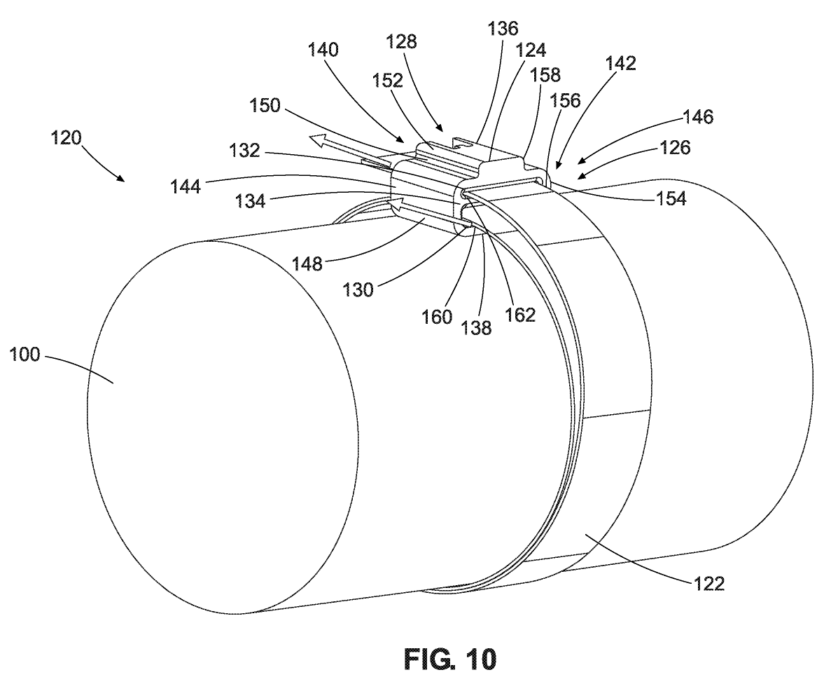

FIG. 10 illustrates another embodiment of a double stack ball locking cleat 120 of the present invention. The double stack ball locking cleat 120 includes a strap 122 and a housing 124. In certain instances, the strap 122 may include a continuous knurled recess extending along a length of the strap 122. In other instances, the strap 122 may include markings along a length of the strap to indicate tension, length, or positioning. The strap 122 may be fed through the housing 124 to surround a cable (e.g., cable 100 illustrated in FIGS. 1 and 2) or a bundle of cables. As such, the double stack ball locking cleat 120 may be installed around the cable, the bundle of cables, and so on.

The housing 124 may define an interior space that includes a strap portion 126 and a ball lock portion 128. The strap portion 126 may include a lower aperture 130 and an upper aperture 132, which may be separated by a divider 134 of the housing 124. The ball lock portion 128 may extend from the upper aperture 132 such that a component positioned within the ball lock portion 128 may couple to and/or interact with a component positioned within the upper aperture 132.

The housing 124 includes a top 136, a bottom 138, a front 140, a back 142, a first side 144, and a second side 146. The first side 144 of the housing 124 may include a first vertical portion 148, a first horizontal portion 150 extending from the first vertical portion 148, and a second vertical portion 152 extending from the first horizontal portion 150. The second side 146 of the housing 124 may include a third vertical portion 154, a second horizontal portion 156 extending from the third vertical portion 154, and a fourth vertical portion 158 extending from the second horizontal portion 156. The first vertical portion 148 and the third vertical portion 154 may couple to the bottom 138. The second vertical portion 152 and the fourth vertical portion 158 may couple to the top 136.

The housing 124 may be smaller than housings of traditional embodiments. For example, traditional embodiments may include housings with lengths between 30 and 40 millimeters (mm), a width between 20 and 25 mm, and a height between 10 to 20 mm. In contrast, the housing 124 may include a length between 13 and 17 mm, a width between 20 and 25 mm, and a height between 20 and 25 mm. A smaller housing 124 may improve installation operations. For example, it may be easier to provide the strap 122 through the strap portion 126 of the housing 124. In another example, it may be easier to position the housing 124 with respect to the cable 100 or the bundle of cables.

The ball lock portion 128 may include the interior space defined by the second vertical portion 152, the top 136, and the fourth vertical portion 158. As further discussed herein, the ball lock portion 128 may be configured to receive a locking ball to secure the strap 122 to the housing 124. The strap portion 126 may include the interior space defined by the first vertical portion 148, the first horizontal portion 150, the bottom 138, the third vertical portion, and the second horizontal portion 156. As illustrated in FIG. 10, a width of the strap portion 126 may be greater than a width of the ball lock portion 128.

The lower aperture 130 and the upper aperture 132 may define pathways for the strap 122. For example, the lower aperture 130 extends from the front 140 to the back 142 and defines a first pathway 160 for the strap 122. In another example, the upper aperture 132 extends from the front 140 to the back 142 and defines a second pathway 162 for the strap 122.

As discussed herein, the lower aperture 130 and the upper aperture 132 may be separated by the divider 134. For example, the divider 134 may extend from the first vertical portion 148 of the first side 144 to the third vertical portion 154 of the second side 146 to divide the interior space of the strap portion 126. The divider 134 may also extend from the front 140 to the back 142.

In certain embodiments, the divider 134 may include tie body lock recess (e.g., cast depression form) that receives the strap 122 may be positioned in the upper aperture 132. The tie body lock recess may be formed in the housing 124 during the casting process. The tie body lock recess may be configured to couple to a locking ball, thereby reducing the likelihood of misaligning the locking ball and/or reducing the number of components used to secure the strap 122. As such, the double stack ball locking cleat 120 may provide a repeatable and consistent relationship between the tie body lock recess and the locking ball.

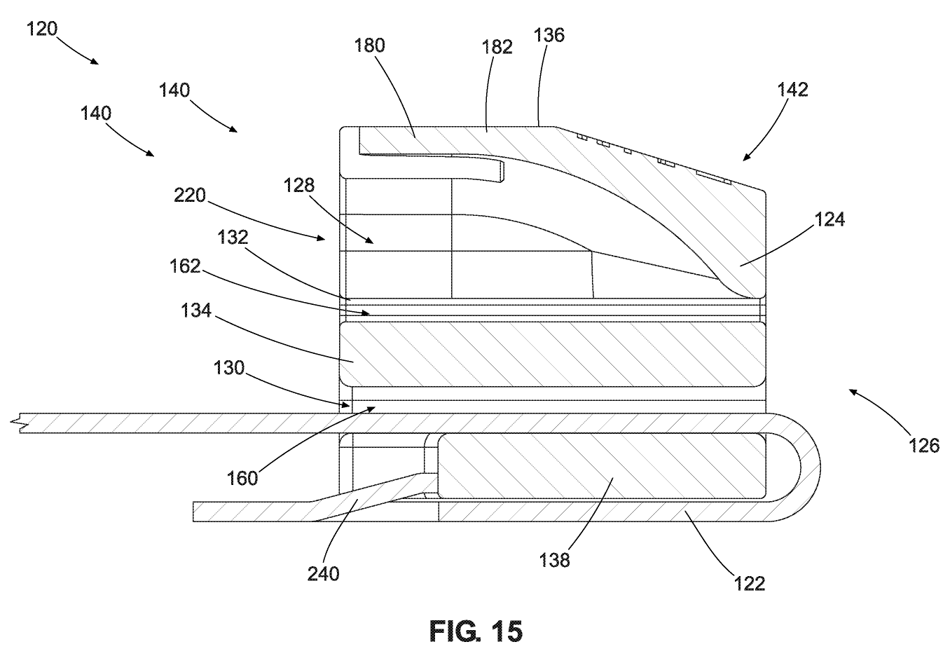

The housing 124 may include a notch 164 positioned in the bottom 138. The notch 164 may be a recessed portion in the bottom 138 or removed portion from the bottom 138. As such, a portion of the bottom 138 may be smaller, such as a length of the portion of the bottom 138, than a length of the divider 134. As illustrated in FIG. 15, the notch 164 may receive a lance form of the strap 122 to couple the strap 122 to the housing 124. Additionally, or alternatively, the notch 164 and/or the lance form may be configured to maintain a position of the housing 124 with respect to the cable 100 or the bundle of cables 100 after installation.

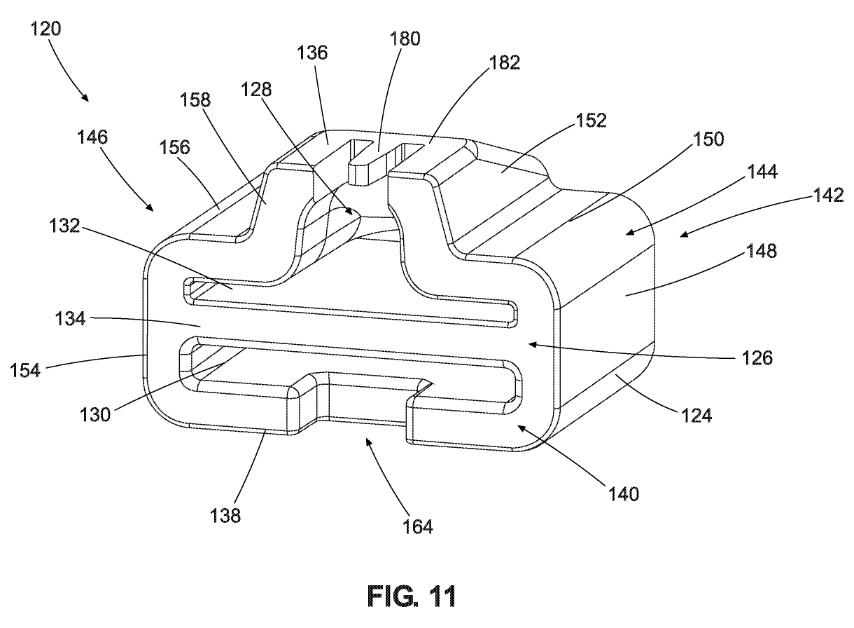

FIG. 11 illustrates a front view of the housing 124 of the double stack ball locking cleat 120 with a ball retention tab 180 in an unfolded position (e.g., first configuration). The housing 124 of the double stack ball locking cleat 120 may be manufactured using a single die. For example, the housing 124 may include a single cast stainless steel component. When manufacturing the housing 124, the housing 124 may be cast with the ball retention tab 180 in the unfolded position using a single die and may not include any steps of welding. The one piece design may reduce a number of steps in the manufacturing process, which may reduce manufacturing complexity, improve ease of assembling, improve cost-efficiency, and so on. It should be understood that the housing 124 may be made from any suitable material.

The top 136 of the housing 124 may include a body 182 coupled to the second vertical portion 152 of the first side 144 and the fourth vertical portion 158 of the second side 146. The ball retention tab 180 may extend from the body 182 towards the front 140. In the unfolded position, the ball retention tab 180 may extend from the body 182 in a horizontal direction.

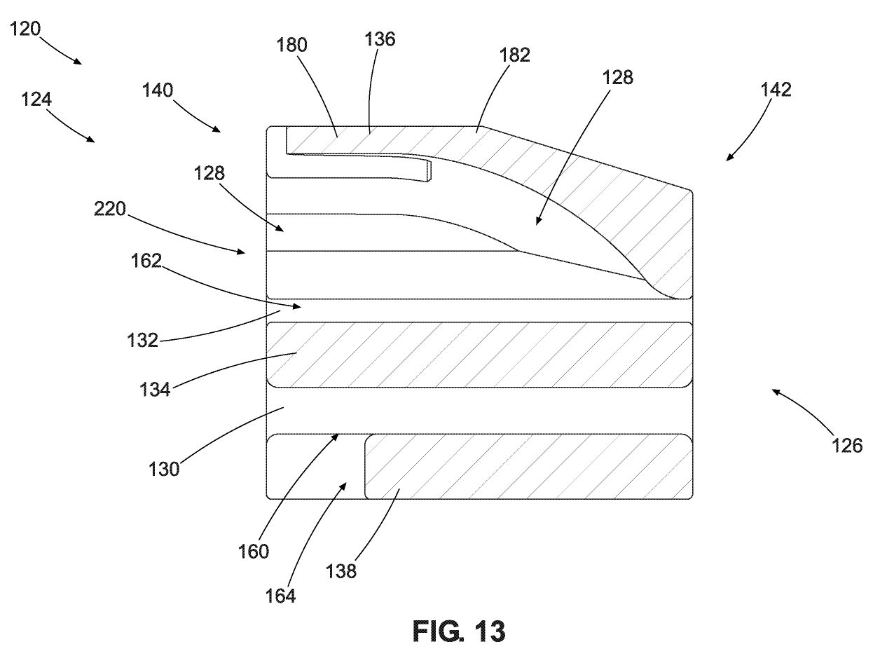

As illustrated in FIG. 13, the ball lock portion 128 may be open at the front 140 and tapered to close at the back 142. For example, the top 136 may increase in thickness from the front 140 to the back 142 such that a height of the ball lock portion 128 may decrease from the front 140 to the back 142. That is, the top 136 may provide a ramped surface. The ramped surface may provide for a tapered at closed end at the back 142 of the housing 124. For example, as illustrated in FIGS. 10 and 13, the ball lock portion 128 may not include an opening at the back 142.

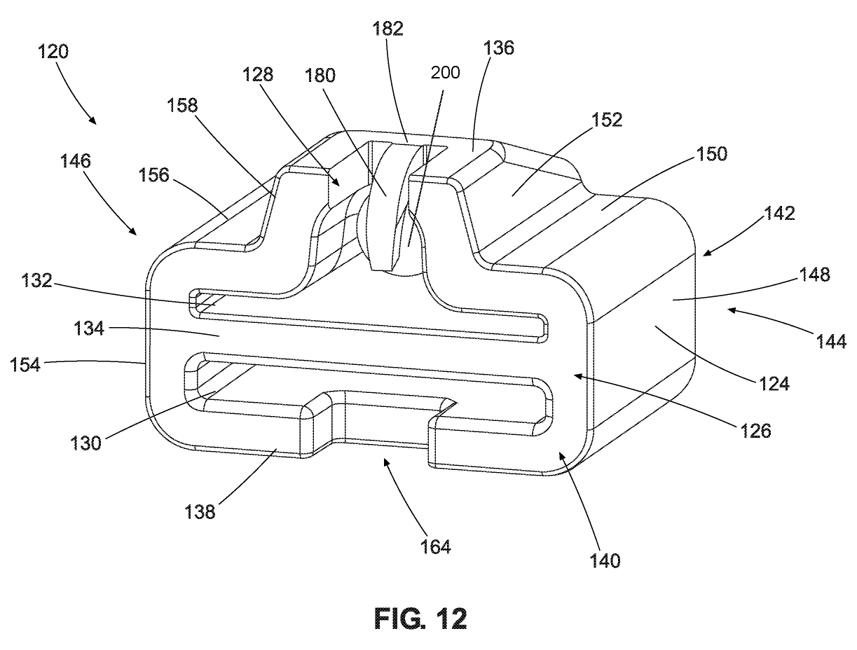

FIG. 12 illustrates a front view of the housing 124 of the double stack ball locking cleat 120 with the ball retention tab 180 in a folded position (e.g., second configuration) and a locking ball 200 positioned in the ball lock portion 128. After manufacturing the housing 124, the locking ball 200 may be inserted into the ball lock portion 128 via the opening of the ball lock portion 128 positioned at the front 140 of the housing 124. After inserting the locking ball 200, the ball retention tab 180 may be transitioned from the unfolded position to the folded position to maintain the position of the locking ball 200 within the ball lock portion 128. In the folded position, the ball retention tab 180 may be perpendicular to the body 182, for example. In another example, an angle may be formed between the ball retention tab 180 and the body 182 in the folded position.

During installation of the double stack ball locking cleat 120, the locking ball 200 may be moved from the front 140 to the back 142 by the strap 122. As the height of the top 136 decreases, the locking ball 200 may couple to the top 136 and/or be locked into place by the top 136. That is, the locking ball 200 may be retained by the ball lock portion 128, which may be shaped as a tapered channel defined by the top 136 and the divider 134.

With the foregoing in mind, the double stack ball locking cleat 120 may be installed around the cable 100 or the bundle of cables 100, and the strap 122 may be locked into place by the locking ball 200. For example, the double stack ball locking cleat 120 may be installed by looping the strap 122 around a cable 100 or a bundle of cables 100 and fed through the lower aperture 130. The strap 122 may be wrapped around the cable 100 or the bundle of cables and fed through the lower aperture 130 once, twice, or any number of times, as desired. For example, the strap 122 may be wrapped five times around the cable 100 or the bundle of cables. After the strap 122 wrap around is completed, the strap 122 is fed through the upper aperture 132 and locked into place by the locking ball 200 positioned in the ball lock portion 128. For example, the strap 122 extends through the second pathway 162 so that it is positioned between the divider 134 and the locking ball 200. For example, the strap 122 may be tensioned with a battery powered cable tie installation tool or a modified cable tie installation style tool. In certain instances, a portion of the strap 122 (e.g., a free end of the strap 122) may be cut to be flush with the front 140 of the housing 124. As tension on the strap 122 increases, the strap 122 begins to move the locking ball 200 towards the tapered end of the ball lock portion 128. In other instances, the strap 122 may move the locking ball 200 towards the locking displacement hole in the divider 134. As a result, the locking ball 200 and the strap 122 may be locked into place. The strength of the double stack ball locking cleat 120 may be based on the number of loops surrounding the cable 100 or the bundle of cables and/or the cross-sectional area of the double stack ball locking cleat 120. The strap 122 may be tensioned and cut off without the need to rotate the tool over the head.

FIG. 13 illustrates a cross-sectional view of the housing 124 of the double stack ball locking cleat 120. As discussed herein, the housing 124 may include the strap portion 126 and the ball lock portion 128. The ball lock portion 128 may be positioned on top of the strap portion 126.

The strap portion 126 may include the lower aperture 130 and the upper aperture 132, which may be separated by the divider 134. The divider 134 may be positioned in any suitable position within the housing 124. For example, the divider 134 may be positioned at a middle of the strap portion 126 and a size of the upper aperture 132 may be the same as a size of the lower aperture 130. In another example, the divider 134 may be positioned at an upper third of the strap portion 126 and a size of the upper aperture 132 may be less than a size of the lower aperture 130.

The ball lock portion 128 may include an opening 220 positioned at the front 140 configured to receive the locking ball 200 and closed end at the back 142. The ball lock portion 128 may be defined by the top 136, which may increase in thickness from the opening to the closed end, and the divider 134 which may extend from the back 142 in a horizontal direction. As discussed herein, the top 136 may provide a ramped surface, which may couple to and/or lock the locking ball 200 into place.

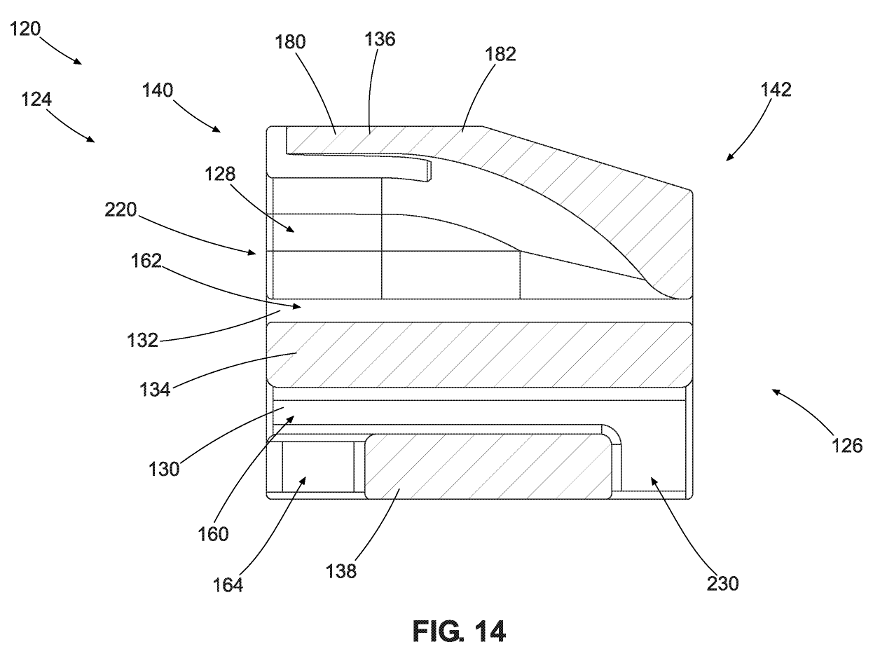

FIG. 14 illustrates a cross-sectional view of the housing 124 of the double stack ball locking cleat 120. In certain instances, a length of the bottom 138 may be less than a length of the divider 134 and/or the length of the housing 124. For example, the housing 124 may include the notch 164 positioned at the front 140 of the housing 124 and a gap 230 positioned at the back 142 of the housing 124. The gap 230 may be a removed portion of the bottom 138, thereby reducing a length of the bottom 138. A smaller housing 124 and/or a shorter bottom 138 may improve installation of the double stack ball locking cleat 120. For example, a shorter bottom 138 may improve alignment and/or positioning between the double stack ball locking cleat 120 and the cables 100, which may improve installation of the double stack ball locking cleat 120 and/or reduce installation time. Additionally, or alternatively, removing a portion of the bottom 138 and/or reducing a length of the housing 124 may reduce an amount of material used to manufacture the housing 124 and/or reduce a weight of the housing 124.

FIG. 15 illustrates a cross-sectional view of the strap 122 fed through the housing 124. The housing 124 may include the notch 164 at the front 140, and the notch 164 may be configured to receive a lance form 240. The lance form 240 may be coupled to the strap 122 at a first end. For example, as illustrated, the lance form 240 may include a louvered lance form. However, it should be understood that the lance form 240 may include any suitable lance form 240.

To install the strap 122 in the housing 124, the lance form 240 may be positioned in the notch 164 of the housing 124. The strap 122 may couple to the bottom 138 and a second end of the strap 122 may be inserted into the lower aperture 130 via the back 142 of the housing 124. The strap 122 may extend through the first pathway 160 formed by the lower aperture 130 and the strap 122 may surround the cable 100 or the bundle of cables. The strap 122 may be wrapped around the cable 100 or the bundle of cables any number of times, and then the second end of the strap 122 may be inserted into the upper aperture 132 via the back 142 of the housing 124. The strap 122 may extend through the second pathway 162 formed by the upper aperture 132 and exit the housing 124 via the opening 220. To lock the strap 122 into position, the locking ball 200 may be inserted into the housing 124 via the opening 220. The second end of the strap 122 may be tensioned by pulling the strap 122 away from the front 140 of the housing 124, which may cause the locking ball 200 to move towards the back 142 of the housing 124. Once the strap 122 is tensioned, the strap 122 may be cut. As such, the double stack ball locking cleat 120 may be installed around the cable 100 or the bundle of cables.

The double stack locking cleat of the present invention provides range taking options allowing the strap to be wrapped around various cable or cable bundle sizes. The double stack locking cleat is inexpensive to manufacture and install. The double stack locking cleat can be installed with common tools while wearing gloves. The double stack locking cleat may also be installed in confined spaces.

The double stack ball locking cleat of the present invention may be wrapped around various cables and/or cable bundle sizes. The housing of the double stack ball locking cleat may be shorter in length than traditional embodiments, which may improve installation on cables and/or bundles of cables with small diameters. The shorter housing and/or the shorter bottom may improve installation of the strap through the lower aperture and/or improve threading multiple strap (e.g., tie) loops through the lower aperture. Additionally, or alternatively, manufacturing the double stack ball locking cleat may use less material, may be more light weight, and be more cost effective than traditional embodiments.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

What is claimed is:

1. A ball locking cleat, comprising:
a housing a top, a bottom, a front, a back, a first side, a second side, and a divider, wherein the housing is configured to define an interior space, and wherein the interior space comprises:
a lower aperture positioned between the bottom and the divider;
an upper aperture positioned between the divider and the top; and
a ball lock portion extending from the upper aperture;
a strap configured to be positioned within the lower aperture, the upper aperture, or both; and
a locking ball configured to be positioned within the ball locking portion and couple to the strap.

2. The ball locking cleat of claim 1, wherein the top comprises:
a body coupled to the first side and the second side; and
a ball retention tab extending from the body, wherein the ball retention tab is configured to transition between a first configuration and a second configuration, wherein the ball retention tab is configured to position the locking ball in the ball lock portion in the second configuration.

3. The ball locking cleat of claim 1, wherein a size of the lower aperture is the same as a size of the upper aperture.

4. The ball locking cleat of claim 1, wherein a size of the lower aperture is greater than a size of the upper aperture.

5. The ball locking cleat of claim 1, wherein a length of the bottom is less than a length of the divider.

6. The ball locking cleat of claim 1, wherein the housing comprises a notch positioned in the front of the housing.

7. The ball locking cleat of claim 1, wherein the divider extends from the first side to the second side to divide the interior space into the lower aperture and the upper aperture.

8. The ball locking cleat of claim 1, wherein the top extends from the front to the back, and wherein a thickness of the top increases from the front to the back.

9. The ball locking cleat of claim 8, wherein the ball lock portion is defined by an opening at the front, a closed end at the back, and the top.

10. The ball locking cleat of claim 9, wherein the locking ball is configured to couple to the top and the strap.

11. The ball locking cleat of claim 1, wherein the lower aperture extends from the front to the back and defines a pathway for the strap.

12. The ball locking cleat of claim 1, wherein the upper aperture extends from the front to the back and defines a pathway for the strap.

13. The ball locking cleat of claim 1, wherein the housing is manufactured using a single die.

14. A ball locking cleat, comprising:
a housing comprising a lower aperture, an upper aperture, and a ball lock portion; and
a strap configured to:
surround one or more cables and threaded through the lower aperture; and
threaded through the upper aperture and coupled to a locking ball.

15. The ball locking cleat of claim 14, wherein the housing comprises a divider extending from a first side of the housing to a second side of the housing, wherein the divider is configured to divide the lower aperture and the upper aperture.

16. The ball locking cleat of claim 14, wherein the housing comprises a top, a bottom, a front, a back, a first side, and a second side, wherein top comprises a ball retention tab configured to transition between a first configuration and a second configuration.

17. The ball locking cleat of claim 16, wherein the ball retention tab is configured to position the locking ball in the ball lock portion in the second configuration.

18. The ball locking cleat of claim 16, wherein the ball locking portion comprises:
an opening positioned at the front and configured to receive the locking ball; and
a closed end positioned at the back.

19. The ball locking cleat of claim 18, wherein a width of the top is configured to increase from the front to the back, and wherein the locking ball is configured to couple to the top and the strap.

20. The ball locking cleat of claim 14, wherein the housing is manufactured using a single die.
